(19) United States
(12) Patent Application Publication
(10) Pub. No.: US 2018/0037360 A1
(43) Pub. Date: Feb. 8, 2018

(54) Container With Edge Protection Features

(71) Applicant: Graphic Packaging International, Inc., Atlanta, GA (US)

(72) Inventors: Joseph C. Walsh, Boulder, CO (US); Michael L. Schlauch, Boulder, CO (US)

(21) Appl. No.: 15/668,054

(22) Filed: Aug. 3, 2017

Related U.S. Application Data
(60) Provisional application No. 62/371,410, filed on Aug. 5, 2016.

(51) Int. Cl. B65D 5/42; B65D 65/42; B32B 27/32; B32B 29/00; B32B 27/10; B65D 5/50

(52) U.S. Cl. CPC B65D 5/4279; B32B 27/10; B65D 5/50; B32B 27/32; B32B 29/005; B65D 65/42; B32B 2307/7265; B32B 2439/70; B32B 2255/12; B32B 2255/26

(57) ABSTRACT

A container for holding a food product includes a bottom wall, a side wall, and a flange extending from the side wall. The bottom wall, the side wall, and the flange include a base layer, and the bottom wall and the side wall cooperate to at least partially define a cavity of the container. The container also includes an interior surface at least partially forming the cavity, an exterior surface opposite the interior surface, and an edge at the flange that extends between the interior surface and the exterior surface. A coating at least partially covers the base layer and at least partially defines the interior surface, and the edge includes an uncoated portion of the base layer. A protective strip covers the edge and prevents fluid from passing into the uncoated portion of the base layer at the edge.

### CROSS-REFERENCE TO RELATED APPLICATION

This application claims the benefit of U.S. Provisional Patent Application No. 62/371,410, filed on Aug. 5, 2016.

### INCORPORATION BY REFERENCE

The disclosure of U.S. Provisional Patent Application No. 62/371,410, filed on Aug. 5, 2016, is hereby incorporated by reference for all purposes as if presented herein in its entirety.

### BACKGROUND OF THE DISCLOSURE

The present disclosure relates to blanks, containers, trays, constructs, and various features to facilitate forming a container from a blank. More specifically, the disclosure is generally directed to a container or tray having edge protection features.

Prior art food trays such as those disclosed in U.S. Pat. No. 8,741,443 are known to include two layers of paperboard, a waterproof coating (e.g., polyethylene) on the inside surface of the tray for contact with the food product and a moisture-proof coating (e.g., acrylic) on the bottom surface of the tray. Such trays have edges at a flange region that are uncoated such that moisture can be absorbed into the paperboard layers at the edges of the flange. When fluids such as moisture are absorbed at the flange area of the tray, the flanges of the tray can become stained and visibly unattractive to consumers and can be structurally weakened by the high moisture absorption that is concentrated at the flange area. The entire content of U.S. Pat. No. 8,741,443 is incorporated by reference herein for all purposes.

The tray or container of the present disclosure improves on conventional food trays such as are disclosed in the '443 patent by including edge protection features to minimize, inhibit, and/or prevent the moisture absorption in the flange area of the tray and the resulting staining and structural weakening of the tray.

### SUMMARY OF THE DISCLOSURE

In one aspect of the disclosure, a container for holding a food product comprises a bottom wall, a side wall, and a flange extending from the side wall. The bottom wall and the side wall cooperate to at least partially define a cavity of the container, and the bottom wall, the side wall, and the flange comprise a base layer. The container also comprises an interior surface that at least partially forms the cavity, an exterior surface opposite the interior surface, and an edge at the flange that extends between the interior surface and the exterior surface. A coating at least partially covers the base layer and at least partially defines the interior surface, and the edge comprises an uncoated portion of the base layer. A protective strip covers the edge and prevents fluid from passing into the uncoated portion of the base layer at the edge.

In another aspect of the disclosure, a blank for forming a container for holding a food product in combination with a protective strip comprises a bottom wall portion of the blank, a side wall portion of the blank, and a flange portion of the blank extending from the side wall portion. The bottom wall portion and the side wall portion are for cooperating to at least partially define a cavity of the container fainted from the blank, and the bottom wall portion, the side wall portion, and the flange portion comprise a base layer. The blank also comprises an interior surface for at least partially forming the cavity, an exterior surface opposite the interior surface, and an edge at the flange portion of the blank that extends between the interior surface and the exterior surface. A coating at least partially covers the base layer and at least partially defines the interior surface, and the edge comprises an uncoated portion of the base layer. The protective strip covers the edge and prevents fluid from passing into the uncoated portion of the base layer at the edge.

In another aspect of the disclosure, a method of forming a container for holding a food product comprises obtaining a blank having a protective strip, the blank comprising a bottom wall portion, a side wall portion, and a flange portion extending from the side wall portion. The bottom wall portion, the side wall portion, and the flange portion comprise a base layer, an interior surface, an exterior surface opposite the interior surface, and an edge at the flange portion of the blank that extends between the interior surface and the exterior surface. A coating at least partially covers the base layer and at least partially defines the interior surface, and the edge comprises an uncoated portion of the base layer. The method further comprises forming a bottom wall from the bottom wall portion, a side wall from the side wall portion, and a flange from the flange portion, and the bottom wall and the side wall cooperate to at least partially define a cavity formed in the interior surface of the blank. The protective strip covers the edge at the flange and prevents fluid from passing into the uncoated portion of the base layer at the edge.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a blank for forming a container according to one exemplary embodiment of the disclosure.

FIG. 2 is a plan view of the blank of FIG. 1 including a protective strip applied thereon.

FIG. 3 is a cross-sectional view taken along the line 3-3 of FIG. 2.

FIG. 4 is a container forming from the blank and protective strip of FIG. 2.

FIG. 5 is a perspective view of the container of FIG. 4 including a cover and containing a food product.

FIG. 6 is a schematic view of an apparatus for forming the container of FIG. 4.

Corresponding parts are designated by corresponding reference numbers throughout the drawings.

### DETAILED DESCRIPTION OF THE EXEMPLARY EMBODIMENTS

The present disclosure relates generally to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to a container or tray for holding food items or various other articles. However, in other embodiments, the container or tray can be used to hold other non-food containing articles or may be used for heating or cooking.

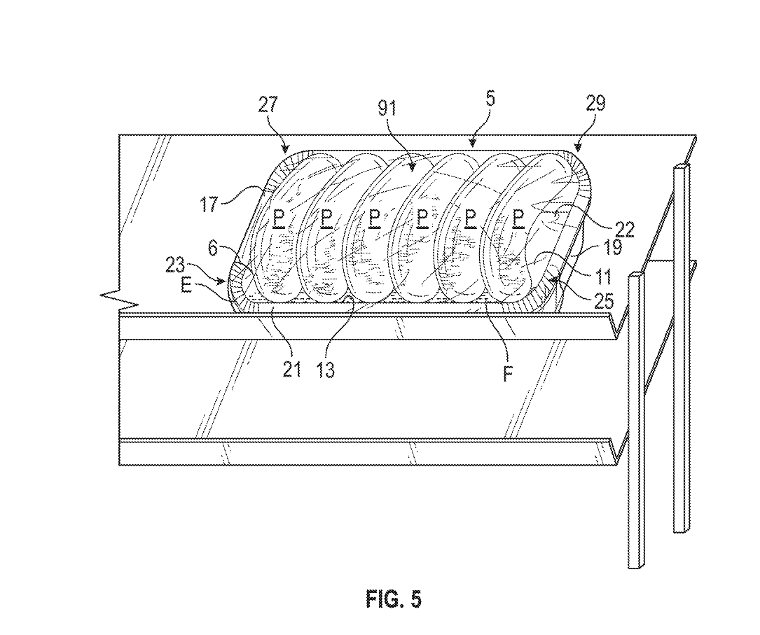

Referring initially to FIG. 4, the present disclosure is generally directed to a container or tray 5 that includes edge protection features including a protective strip 6 that at least partially overlies or covers an edge E of the container 5 to minimize, inhibit, and/or prevent fluids such as moisture from being transmitted to the material of the container 5 through an edge E of the container 5. The container 5 can be used to hold a food product P (FIG. 5), such as a meat product that can be frozen or unfrozen. The container 5 may hold other types of food products without departing from the disclosure. In use, the container 5 may be tipped or raised at an angle to better display the food product P, such as in a retail grocery store or other location. In such instances, fluids F, e.g., melted ice or other runoff from the food product P, or other fluids from the environment such as condensation, can travel across portions of the container 5 under the influence of gravity. The protective strip 6 minimizes, inhibits, and/or prevents such fluids in the container 5 from being absorbed into the material of the container 5 through the uncoated edge E of the container 5. As noted below, the container 5 and protective strip 6 can have other features as shown and/or described herein.

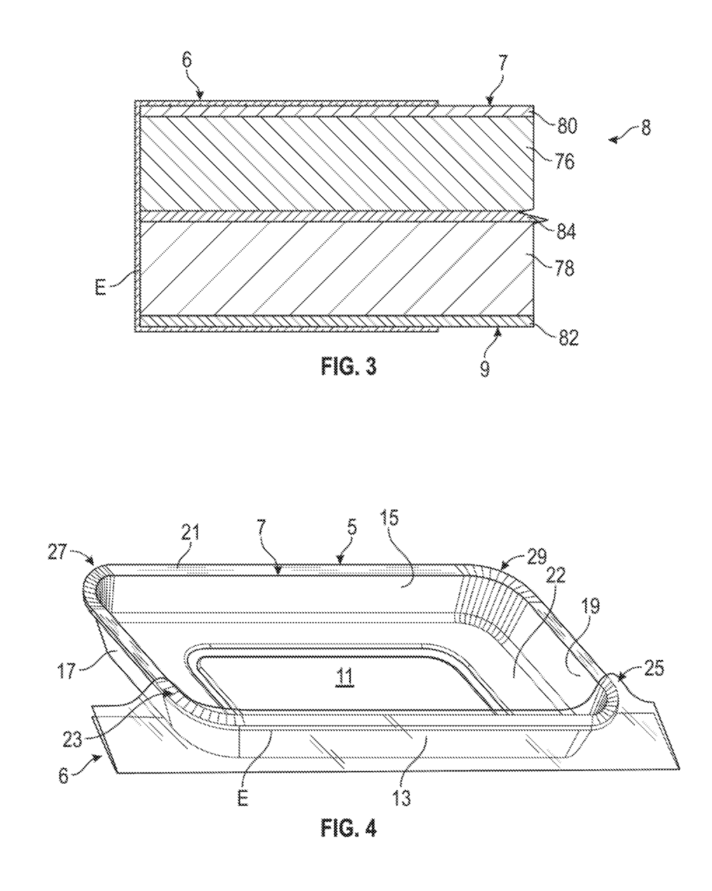

FIGS. 4 and 5 illustrate the container 5 in in the form of a tray in accordance with the disclosure and having an interior surface 7, a bottom wall 11, two side walls 13, 15, and two end walls 17, 19. In the illustrated embodiment, the container 5 has four corners 23, 25, 27, 29 connecting respective side walls 13, 15 and end walls 17, 19. A flange 21 extends outwardly from the side walls 13, 15, end walls 17, 19, and corners 23, 25, 27, 29, and extends around the perimeter of the container 5. The side walls 13, 15 and the end walls 17, 19 extend from the bottom wall 11, and one or more of the side walls 13, 15 and the end walls 17, 19 cooperate with the bottom wall 11 to at least partially define a cavity 22 of the container 5. In particular, an interior surface 7 (FIG. 3) of the container 5 along the side walls 13, 15, the end walls 17, 19, the bottom wall 11, and the flange 21 to form the cavity 22. The cavity 22 is for holding the food product P and/or another article. Referring additionally to FIG. 3, in one embodiment, the container 5 comprises material similar to the material disclosed in the '443 patent in that the container 5 comprises a base layer or laminate material 8 comprising two layers of paperboard 76, 78. In this regard, the side walls 13, 15, the end walls 17, 19, the corners 23, 25, 27, 29, and the flange 21 of the container 5 comprise the base layer 8. The layers of paperboard 76, 78 can be attached by a layer of adhesive 84, as shown. A waterproof coating 80 is disposed on the face of the upper layer of paperboard 76, and a moisture-proof coating 82 is disposed on the face of the lower layer of paperboard 78. In this regard, the waterproof coating 80 forms the interior surface 7 of the container 5 and can comprise various suitable waterproof coatings such as polyethylene extrusion coating or other suitable waterproof coatings. The moisture-proof coating 82 can be, for example, a water-based acrylic aqueous coating, and provides a moisture-proof barrier on the bottom of the container 5 and forms the exterior surface 9 of the container 5. The moisture-proof coating 82 can be any suitable material that is resistant to fluids F (FIG. 5), for example, moisture, but not waterproof. In embodiments, the container 5 could comprise a single layer of paperboard without departing from the disclosure, and/or one or more of the layers 76, 78 could be materials other than paperboard without departing from the disclosure. In the illustrated embodiment, the coatings 80, 82 are not disposed on the edge E such that the edge E is an uncoated portion of the base layer 8. As shown, the container 5 includes a protective strip 6 attached to a portion of the container 5 that includes a portion of the bottom wall 11, the side wall 13, and the corners 23, 25. In this regard, the protective strip 6 is attached to both the interior surface 7 and the exterior surface 9 of the container 5 and overlies at least a portion of the edge E along the side wall 13 and corners 23, 25, and a portion of the end walls 17, 19 to provide a protective seal on the edge E. While the protective strip 6 is illustrated extending past the edge E of the container 5, in embodiments, the protective strip 6 can be crimped or overlapped near the edge E of the container 5.

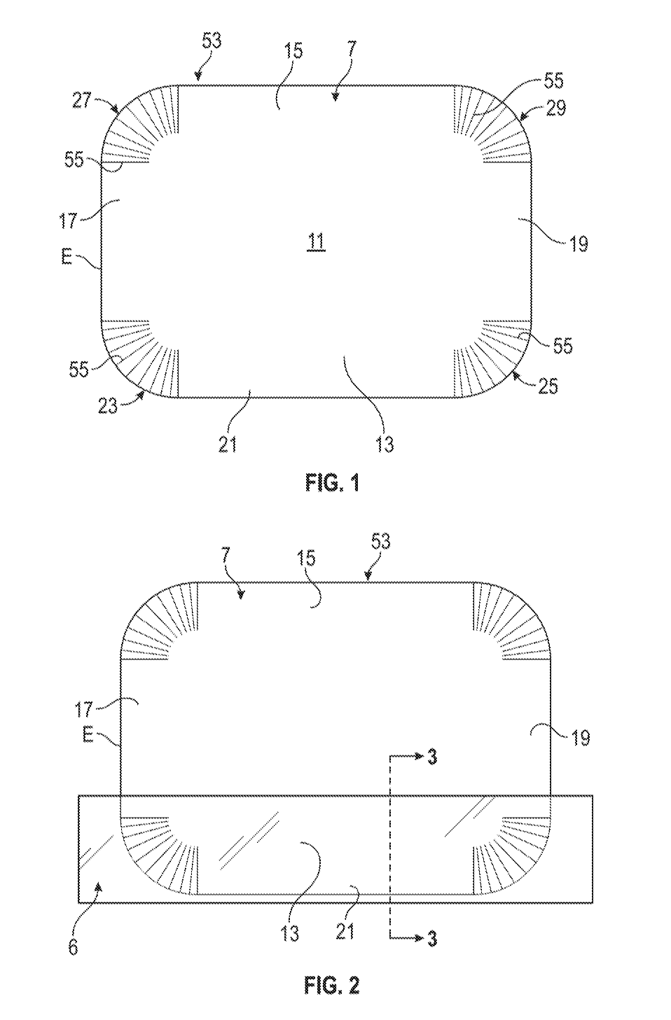

Referring to FIG. 1, a blank 53 for forming the container or tray 5 (FIG. 4) is illustrated. The blank 53 has corresponding portions that are formed into the side walls 13, 15, end walls 17, 19, corners 23, 25, 27, 29 and the flange 21 that extends around the perimeter of the blank 53 and the container 5. The corner portions 23, 25, 27, 29 of the blank 53 have score lines 55 to facilitate the forming of the corners 23, 25, 27, 29 during the forming, for example, press-forming, of the blank 53 into the container 5. In one embodiment, the blank 53 comprises the two layers of paperboard 76, 78, the waterproof coating 80 that forms the interior surface 7 of the blank 53 and the container 5, and the moisture resistant-coating 82 that forms the exterior surface 9 (FIG. 3) of the blank 53 and the container 5. The edge E of the blank 53 corresponds with the edge E of the container 5 and extends around the perimeter of the blank 53. As shown in FIG. 3, the coatings 80, 82 do not extend between the interior surface 7 and the exterior surface 9 of the blank 53 such that the edge E of the blank 53 is exposed or uncoated. The blank 53 could have other features and materials without departing from the disclosure.

As shown in FIGS. 2 and 3, the protective strip 6 is attached to a portion of the blank 53 so that the protective strip 6 covers a portion of the interior surface 7, a portion of the exterior surface 9, and the edge E. In this regard, the protective strip 6 can be wrapped around a portion of the interior surface 7 and the exterior surface 9 of the blank 53. In other embodiments, separate protective strips 6 can be applied to the respective interior surface 7 and exterior surface 9 of the blank 53. In one embodiment, the protective strip 6 covers the side wall 13, the corners 23, 25, and the flange 21 that extends around the side wall 13 along the interior surface 7 and the exterior surface 9 of the blank 53. The protective strip 6 can be alternatively configured to cover more of the edge E such as the edge of the side wall 15 and the corners 27, 29 without departing from the disclosure. In embodiments, the protective strip 6 can cover the entirety of the edge E without departing from the disclosure, or the protective strip 6 can cover less of the edge E than illustrated without departing from the disclosure.

The protective strip 6 can comprise a polymer liner that comprises a material such as polyethylene film (e.g., PET or polyethylene terephthalate film) or other polymer film or any other suitable material that can be adhered to the blank 53, e.g., along portions that form the flange 21 and/or the side walls 17, 19 of the container 5 (FIG. 4) and at least partially overlie or cover the edge E to seal the edge E and prevent fluids F, such as moisture, from being transmitted onto and/or into the edge E. In this regard, the protective strip 6 minimizes, inhibits, and/or prevents fluids F, such as moisture, from being absorbed into the paperboard layers 76, 78 at the edge E. The protective strip 6 can be otherwise shaped, arranged, and/or configured without departing from this disclosure.

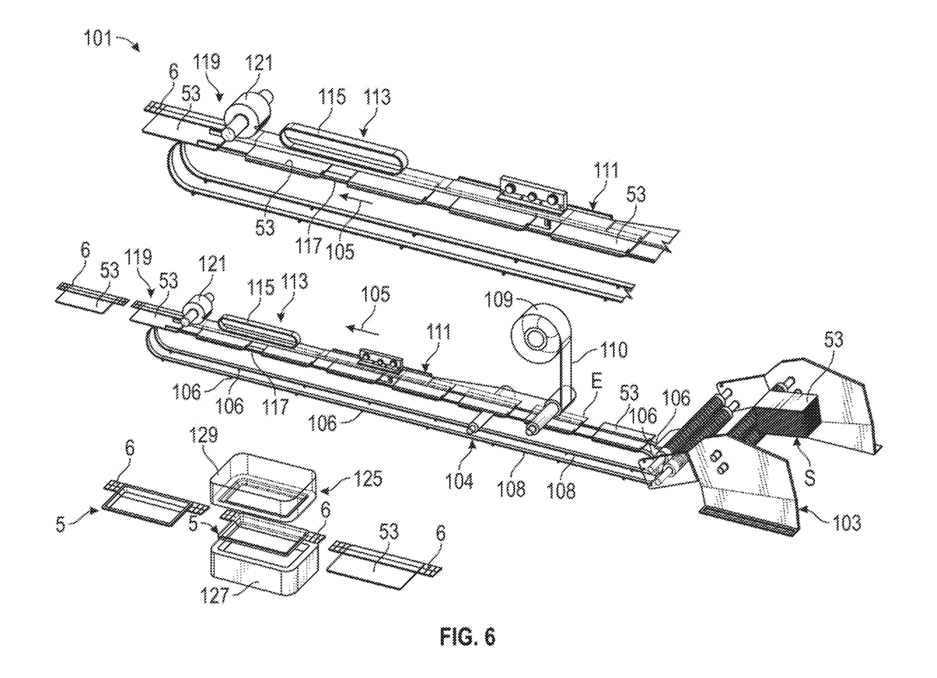

As shown in FIGS. 5 and 6, the container 5 includes a cover or lid 91 that comprises packaging film, e.g., a thin plastic or other polymeric layer, that covers the container 5 and is wrapped around the container 5 and seals the container 5 to preserve and protect the food product P contained in the cavity 22 of the container 5. In one embodiment, the cover 91 is in at least partial face-to-face contact with the flange 21 such that the cover 91 completely covers the flange 21 and extends around and covers at least a portion of the exterior surface 9 of the container 5 so that the cover 91 seals the container 5. Any plastic or polymeric film, such as polyethylene, polypropylene, polyethylene terephthalate, polyvinylchloride, polyamide, and ethylene vinyl alcohol, or other suitable material, can be used. Any other suitable material can be used for forming the cover 91 that seals the food product P in the cavity 22 of the container 5. Further, alternative lid materials can be used in combination with adhesives that can be used between the cover 91 and the sealing surface of the flange 21 or other surfaces of the container 5 without departing from the disclosure. Further, the cover 91 can be otherwise shaped, arranged, configured, or omitted without departing from the disclosure.

FIG. 6 shows a schematic of a system 101 and associated method or process for forming the container 5 with the protective strip 6 from the blank 53 according to one exemplary embodiment of the disclosure. As shown, a blank 53 is fed from a stack S of blanks 53 in a feeder 103 to a conveyor assembly 104 that conveys the blanks 53 in a direction of travel 105. The conveyor assembly 104 can include spaced-apart lugs 106 attached to a respective belt 108 that engage the blanks 53 and move the blanks 53 through the system 101. The blanks 53 are first fed below a supply 109 of poly film 110 that is folded around the blank 53 at the folding station 111. Once the film 110 is folded around the blank 53 to seal at least a portion of the edge E of the blank 53 as described herein, the blank 53 and the film 110 pass to a sealing station 113. At the sealing station, the film 110 is sealed to the interior (top) surface 7 (FIG. 3) and the exterior (bottom) surface 9 (FIG. 3) of the blank 53. In one embodiment, the sealing station 113 includes an upper sealer 115 and a lower sealer 117. The blank 53 with the sealed film 110 then passes to a cutting station 119 for cutting the folded and sealed film 110. In one embodiment, the cutting station 119 includes a rotary sealer and cutting mechanism 121, though the cutting station 119 could be otherwise configured without departing from the disclosure. In embodiments, the cut film 110 can be crimped or overlapped near the edge E of the container 5. After the film 110 has been cut at the cutting station 119, the blanks 53 with the protective strip 6 are ready to be press-formed into the container 5. In one embodiment, a tool 125 can be used to form the blank 53 with protective strip 6 into the form of the container 5. The tool 125 can include a female tool assembly 127 and a male tool assembly 129 that press the blank 53 and protective strip 6 into the container 5. The tool 125 could be otherwise shaped, arranged, and configured without departing from the disclosure.

After forming the container 5, and referring again to FIG. 5, the food product P can be placed in the cavity 22 of the container 5 and the cover 91 is placed over and around the container 5 to seal the food product P in the container 5, for example, to maintain freshness or another desired state of the food product P. As noted above, when the container 5 with food product P that can be frozen, can be typically displayed in an angled orientation for displaying the food product P to the customer. In this regard, the cover 91 may be transparent such that the food product P is visible through the cover 91 in such an orientation. When the food product P thaws, fluid F such as moisture can accumulate in the cavity 22 of the container 5 and will collect near the sealed edge E wherein the protective strip 6 is located. In this regard, the protective strip 6 provides a barrier that covers the edge E and minimizes, inhibits, and/or prevents fluid F from passing into the uncoated paperboard layers 76, 78 at the uncoated or exposed edge E. Accordingly, the strength and integrity of the material of the container 5 is maintained by the presence of the protective strip 6 and the minimization, inhibition, and/or prevention of fluid F such as moisture entering the paperboard layers 76, 78. As noted above, the container 5, protective strip 6 and other features could be otherwise shaped, arranged, and/or configured without departing from the disclosure.

In some embodiments, and with reference to FIG. 3, the base layer 8 could include a single layer of paperboard, or more than two layers of paperboard, without departing from the disclosure. Further, the waterproof coating 80 could be any suitable coating to prevent fluid such as water or moisture from passing directly from the interior surface 7 of the container 5 (FIG. 4) into the paperboard layers 76, 78. Also, the moisture-resistant coating 82 could be any suitable coating to that resists fluid or moisture absorption into the base layer 8. In embodiments, the moisture-resistant coating 82 could be omitted or could be inherent in the properties of the paperboard layer 78 without departing from the disclosure.

It is understood that the base layer 8 for the blank 53 (FIG. 1) can be formed by any suitable process such as disclosed in the '443 patent or any other process. The container 5 (FIG. 4) can be formed from the blank 53 by press forming the container 5 by a forming tool or by any suitable process such as disclosed in the '443 patent or any other process. Also, the blank 53 and the container 5 could be alternatively shaped (e.g., circular, oval, rectangular, annular, irregular, etc.) without departing from the scope of this disclosure.

Any of the features of the various embodiments of the disclosure can be combined with, replaced by, or otherwise configured with other features of other embodiments of the disclosure without departing from the scope of this disclosure.

Optionally, one or more portions of the blank or other constructs described herein or contemplated hereby may be coated with varnish, clay, or other materials, either alone or in combination. The coating may then be printed over with product advertising or other information or images. The blanks or other constructs also may be selectively coated and/or printed so that less than the entire surface area of the blank or substantially the entire surface area of the blank may be coated and/or printed.

All dimensional information presented herein is intended to be illustrative of certain aspects, features, etc., of various embodiments of the disclosure, and is not intended to limit the scope of the disclosure. The dimensions of the blanks, containers, forming tools, features, or any other dimension, can be more or less than what is shown and described in this disclosure without departing from the scope of this disclosure and can be within the listed ranges of dimensions for each feature or outside the listed ranges of dimensions for each feature without departing from the scope of this disclosure.

In accordance with the exemplary embodiments, the blanks may be constructed of paperboard of a caliper such that it is heavier and more rigid than ordinary paper. The blanks can also be constructed of other materials, such as cardboard, hard paper, or any other material having properties suitable for enabling the carton package to function at least generally as described above.

The foregoing description illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, and alterations, etc., of the above-described embodiments. Additionally, the disclosure shows and describes only selected embodiments, but various other combinations, modifications, and environments are contemplated and are within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A container for holding a food product, the container comprising:
a bottom wall, a side wall, and a flange extending from the side wall, the bottom wall and the side wall cooperating to at least partially define a cavity of the container, the bottom wall, the side wall, and the flange comprising a base layer,
an interior surface at least partially forming the cavity, an exterior surface opposite the interior surface, and an edge at the flange, the edge extending between the interior surface and the exterior surface;
a coating at least partially covering the base layer and at least partially defining the interior surface, the edge comprising an uncoated portion of the base layer; and
a protective strip covering the edge and preventing fluid from passing into the uncoated portion of the base layer at the edge.

2. The container of claim 1, wherein the protective strip comprises a polymer liner.

3. The container of claim 2, wherein the protective strip comprises polyethylene terephthalate.

4. The container of claim 2, wherein the protective strip is adhered to at least one of the side wall and the flange.

5. The container of claim 1, wherein the protective strip extends from a portion of the interior surface, across the uncoated portion of the base layer at the edge, and onto a portion of the exterior surface.

6. The container of claim 5, wherein the container further comprises at least one end wall and at least one corner connecting the side wall and the respective at least one end wall.

7. The container of claim 6, wherein the protective strip at least partially overlies the at least one end wall and the at least one corner, and wherein the uncoated portion of the base layer at the edge extends along the at least one end wall and the at least one corner.

8. The container of claim 1, wherein the coating is a moisture-proof coating.

9. The container of claim 8, wherein the coating comprises acrylic.

10. The container of claim 1, wherein the coating is a waterproof coating.

11. The container of claim 10, wherein the coating comprises polyethylene.

12. The container of claim 1, wherein the base layer comprises at least one layer of paperboard.

13. The container of claim 12, wherein the at least one layer of paperboard comprises a first layer of paperboard and a second layer of paperboard.

14. The container of claim 13, wherein the first layer of paperboard and the second layer of paperboard are attached by a layer of adhesive.

15. The container of claim 14, wherein the coating is a first coating on the first layer of paperboard, and the container comprises a second coating on the second layer of paperboard, the second coating at least partially defining the exterior surface.

16. The container of claim 15, wherein the protective strip is attached to the first coating and the second coating.

17. The container of claim 1, further comprising a cover in at least partial face-to-face contact with the flange.

18. The container of claim 17, wherein the cover extends at least partially over the cavity.

19. The container of claim 17, wherein the cover comprises packaging film.

20. A blank for forming a container for holding a food product, the blank in combination with a protective strip, the combination comprising:
a bottom wall portion of the blank, a side wall portion of the blank, and a flange portion of the blank extending from the side wall portion, the bottom wall portion and the side wall portion being for cooperating to at least partially define a cavity of the container formed from the blank, the bottom wall portion, the side wall portion, and the flange portion comprising a base layer,
an interior surface for at least partially forming the cavity, an exterior surface opposite the interior surface, and an edge at the flange portion of the blank, the edge extending between the interior surface and the exterior surface;
a coating at least partially covering the base layer and at least partially defining the interior surface, the edge comprising an uncoated portion of the base layer; and
the protective strip covers the edge and prevents fluid from passing into the uncoated portion of the base layer at the edge.

21. The blank of claim 20, wherein the protective strip comprises a polymer liner.

22. The blank of claim 21, wherein the protective strip comprises polyethylene terephthalate.

23. The blank of claim 21, wherein the protective strip is adhered to at least one of the side wall and the flange.

24. The blank of claim 20, wherein the protective strip extends from a portion of the interior surface, across the uncoated portion of the base layer at the edge, and onto a portion of the exterior surface.

25. The blank of claim 24, wherein the container further comprises at least one end wall portion and at least one corner portion connecting the side wall portion and the respective at least one end wall portion.

26. The blank of claim 26, wherein the protective strip at least partially overlies the at least one end wall portion and the at least one corner portion, and wherein the uncoated portion of the base layer at the edge extends along the at least one end wall portion and the at least one corner portion.

27. The blank of claim 20, wherein the base layer comprises at least one layer of paperboard.

28. The blank of claim 27, wherein the at least one layer of paperboard comprises a first layer of paperboard and a second layer of paperboard.

29. The blank of claim 28, wherein the first layer of paperboard and the second layer of paperboard are attached by a layer of adhesive.

30. The blank of claim 28, wherein the coating is a first coating on the first layer of paperboard, and the container comprises a second coating on the second layer of paperboard, the second coating at least partially defining the exterior surface.

31. The blank of claim 30, wherein the protective strip is attached to the first coating and the second coating.

32. A method of forming a container for holding a food product, the method comprising:
obtaining a blank having a protective strip, the blank comprising a bottom wall portion, a side wall portion, and a flange portion extending from the side wall portion, the bottom wall portion, the side wall portion, and the flange portion comprising a base layer, an interior surface, an exterior surface opposite the interior surface, and an edge at the flange portion of the blank, the edge extending between the interior surface and the exterior surface, a coating at least partially covering the base layer and at least partially defining the interior surface, the edge comprising an uncoated portion of the base layer; and
forming a bottom wall from the bottom wall portion, a side wall from the side wall portion, and a flange from the flange portion, the bottom wall and the side wall cooperate to at least partially define a cavity formed in the interior surface of the blank,
the protective strip covers the edge at the flange and prevents fluid from passing into the uncoated portion of the base layer at the edge.

33. The method of claim 32, wherein the protective strip comprises a polymer liner.

34. The method of claim 33, wherein the protective strip comprises polyethylene terephthalate.

35. The method of claim 33, wherein the protective strip is adhered to at least one of the side wall portion and the flange portion.

36. The method of claim 32, wherein the protective strip extends from a portion of the interior surface, across the uncoated portion of the base layer at the edge, and onto a portion of the exterior surface.

37. The method of claim 36, wherein the blank further comprises at least one end wall portion and at least one corner portion connecting the side wall portion and the respective at least one end wall portion.

38. The method of claim 37, wherein the protective strip at least partially overlies the at least one end wall portion and the at least one corner portion, and wherein the uncoated portion of the base layer at the edge extends along the at least one end wall portion and the at least one corner portion.

39. The method of claim 32, wherein the base layer comprises at least one layer of paperboard.

40. The method of claim 39, wherein the at least one layer of paperboard comprises a first layer of paperboard and a second layer of paperboard.

41. The method of claim 40, wherein the first layer of paperboard and the second layer of paperboard are attached by a layer of adhesive.

42. The method of claim 41, wherein the coating is a first coating on the first layer of paperboard, and the container comprises a second coating on the second layer of paperboard, the second coating at least partially defining the exterior surface.

43. The method of claim 42, wherein the protective strip is attached to the first coating and the second coating.
